(19) United States
(12) Patent Application Publication
(10) Pub. No.: US 2025/0139799 A1
(43) Pub. Date: May 1, 2025

(54) INFORMATION PROCESSING APPARATUS, IMAGE CAPTURING APPARATUS, METHOD, AND NON-TRANSITORY COMPUTER READABLE STORAGE MEDIUM

(71) Applicant: CANON KABUSHIKI KAISHA, Tokyo (JP)

(72) Inventor: Kimihiro MASUYAMA, Tokyo (JP)

(21) Appl. No.: 18/925,095

(22) Filed: Oct. 24, 2024

(30) Foreign Application Priority Data
Oct. 25, 2023 (JP) 2023-183528
Oct. 4, 2024 (JP) 2024-175265

(51) Int. Cl. G06T 7/50

(52) U.S. Cl. CPC G06T 7/50; G06T 2207/30201

(57) ABSTRACT

The at least one processor arranges a three-dimensional model of a subject and a camera in a virtual three-dimensional space. The at least one processor generates a depth map including at least a depth value of a partial region of a region around the subject, based on an image in which the subject appears, the image being rendered based on a photographing field of view of the camera, and distance information corresponding to the photographing field of view. The at least one processor generate a defocus map including a defocus amount of the partial region based on a depth value of the partial region and a photographing parameter of the camera.

### BACKGROUND OF THE INVENTION

### Field of the Invention

The present invention relates to an information processing apparatus, an image capturing apparatus, a method, and a non-transitory computer readable storage medium.

### Description of the Related Art

A camera having a focus adjustment function for automatically adjusting a focus position of a photographing lens is widely used. As a focus adjustment means (AF method) of a camera, a phase difference AF method, a contrast AF method, and the like have been put to practical use. Since the phase difference AF method can directly calculate a shift amount of a focal plane from two images having parallax, the phase difference AF method has an advantage that focusing can be performed more quickly than the contrast AF method.

In recent years, a method of detecting an object region in an image using a neural network (hereinafter referred to as an NN) has been proposed. Tracking a subject with high accuracy while detecting an object in a captured image acquired in real time is a major problem in this field. A parameter input to the NN for image recognition is an RGB color image, but object recognition that takes into consideration a three dimensional context can be realized by also inputting information in the depth direction to the NN in addition to the color image. Here, the shift amount of the focal plane described above can be information in the depth direction.

In order to improve the generalization performance of the NN, a large amount of learning data is required. Data augmentation (hereinafter referred to as DA) is used as a method for improving the generalization performance of the NN even with a small amount of learning data. The DA is a method of artificially expanding learning data by performing processes such as blurring, shaking, image synthesis, rotation, parallel movement, enlargement/reduction, vertical/horizontal inversion, noise addition, color tone change, brightness change, and the like on learning data (e.g., an image).

Japanese Patent Laid-Open No. 2018-163554 proposes a method of increasing the amount of learning data by using three dimensional computer graphics (hereinafter referred to as “3DCG”), changing drawing parameters such as illumination with respect to a three dimensional recognition target model, and simultaneously using rendered images as teacher data. Japanese Patent Laid-Open No. 2021-43839 proposes a method of increasing the amount of learning data by superimposing a first image obtained by rendering a 3D human model on a background image, chipping pixels along a contour of a human body part, and adding noise.

### SUMMARY OF THE INVENTION

According to the present invention, a technique for efficiently acquiring learning data having depth information can be provided.

Some embodiments of the present disclosure provide an information processing apparatus comprising at least one processor, and at least one memory coupled to the at least one processor. The at least one memory stores instructions that, when executed by the at least one processor, cause the at least one processor to arrange a three-dimensional model of a subject and a camera in a virtual three-dimensional space, generate a depth map including at least a depth value of a partial region of a region around the subject, based on an image in which the subject appears, the image being rendered based on a photographing field of view of the camera, and distance information corresponding to the photographing field of view, and generate a defocus map including a defocus amount of the partial region based on a depth value of the partial region and a photographing parameter of the camera.

Some embodiments of the present disclosure provide a method comprising arranging a three-dimensional model of a subject and a camera in a virtual three-dimensional space, generating a depth map including at least a depth value of a partial region of a region around the subject, based on an image in which the subject appears, the image being rendered based on a photographing field of view of the camera, and distance information corresponding to the photographing field of view, and generating a defocus map including a defocus amount of the partial region based on a depth value of the partial region and a photographing parameter of the camera.

Some embodiments of the present disclosure provide a non-transitory computer readable storage medium storing instructions that, when executed by a computer, cause the computer to perform a method comprising arranging a three-dimensional model of a subject and a camera in a virtual three-dimensional space, generating a depth map including at least a depth value of a partial region of a region around the subject, based on an image in which the subject appears, the image being rendered based on a photographing field of view of the camera, and distance information corresponding to the photographing field of view, and generating a defocus map including a defocus amount of the partial region based on a depth value of the partial region and a photographing parameter of the camera.

Some embodiments of the present disclosure provide an information processing apparatus comprising at least one processor, and at least one memory coupled to the at least one processor. The at least one memory stores instructions that, when executed by the at least one processor, cause the at least one processor to arrange a three dimensional model of a subject in a virtual three dimensional space, and arrange three dimensional models of a first camera, a second camera, and a third camera at intervals so that optical axes of the first camera, the second camera, and the third camera are parallel to each other, determine at least a first region around the subject in a double-eye image in which the subject is captured, the double-eye image being rendered based on a first photographing field of view of the first camera, and generate a defocus map including a defocus amount of a partial region of the first region based on parallax information of a partial region of a second region corresponding to the first region in a left-eye image in which the subject is captured, the left-eye image being rendered based on a second photographing field of view of the second camera and a partial region of a third region corresponding to the first region in a right-eye image in which the subject is captured, the right-eye image being rendered based on a third photographing field of view of the third camera.

Some embodiments of the present disclosure provide a method comprising arranging a three dimensional model of a subject in a virtual three dimensional space, and arrange three dimensional models of a first camera, a second camera, and a third camera at intervals so that optical axes of the first camera, the second camera, and the third camera are parallel to each other, determining at least a first region around the subject in a double-eye image in which the subject is captured, the double-eye image being rendered based on a first photographing field of view of the first camera, and generating a defocus map including a defocus amount of a partial region of the first region based on parallax information of a partial region of a second region corresponding to the first region in a left-eye image in which the subject is captured, the left-eye image being rendered based on a second photographing field of view of the second camera and a partial region of a third region corresponding to the first region in a right-eye image in which the subject is captured, the right-eye image being rendered based on a third photographing field of view of the third camera.

Some embodiments of the present disclosure provide a non-transitory computer readable storage medium storing instructions that, when executed by a computer, cause the computer to perform a method comprising arranging a three dimensional model of a subject in a virtual three dimensional space, and arrange three dimensional models of a first camera, a second camera, and a third camera at intervals so that optical axes of the first camera, the second camera, and the third camera are parallel to each other, determining at least a first region around the subject in a double-eye image in which the subject is captured, the double-eye image being rendered based on a first photographing field of view of the first camera, and generating a defocus map including a defocus amount of a partial region of the first region based on parallax information of a partial region of a second region corresponding to the first region in a left-eye image in which the subject is captured, the left-eye image being rendered based on a second photographing field of view of the second camera and a partial region of a third region corresponding to the first region in a right-eye image in which the subject is captured, the right-eye image being rendered based on a third photographing field of view of the third camera.

Further features of the present invention will become apparent from the following description of exemplary embodiments (with reference to the attached drawings).

### BRIEF DESCRIPTION OF THE DRAWINGS

FIG. 1 is a diagram illustrating a hardware configuration of an information processing apparatus according to a first embodiment.

FIG. 2 is a diagram illustrating a functional configuration of an information processing apparatus according to the first embodiment.

FIG. 3 is a diagram illustrating an arrangement of 3D models in a three-dimensional space according to the first embodiment.

FIG. 4 is a flowchart explaining a defocus map generation process according to the first embodiment.

FIG. 5A is an example of distance information 500.

FIG. 5B is a diagram illustrating a depth value calculation region on distance information.

FIG. 6 is a diagram illustrating a functional configuration of an information processing apparatus according to a second embodiment.

FIG. 7 is a diagram illustrating an arrangement of 3D models in a three-dimensional space according to the second embodiment.

FIG. 8A is a diagram explaining alignment of a defocus amount calculation region according to the second embodiment.

FIG. 8B is a diagram explaining alignment of a defocus amount calculation region according to the second embodiment.

FIG. 8C is a diagram explaining alignment of a defocus amount calculation region according to the second embodiment.

FIG. 9 is a flowchart explaining a defocus map generation process according to the second embodiment.

FIG. 10 is a diagram illustrating functional configurations of a learning apparatus and an image capturing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

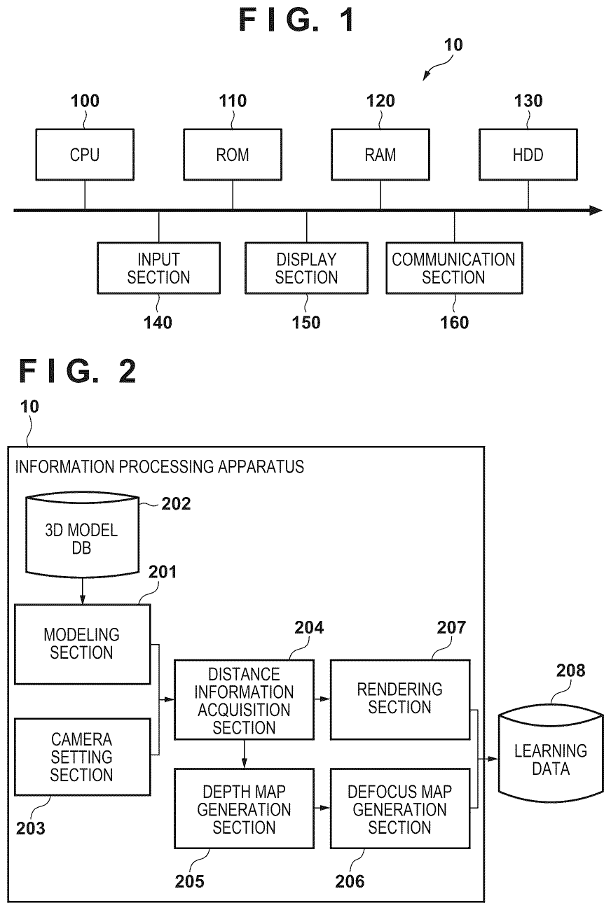

FIG. 1 is a diagram illustrating a hardware configuration of an information processing apparatus according to a first embodiment.

The information processing apparatus 10 is an apparatus that generates learning data of an NN that performs defocus inference. The information processing apparatus 10 includes a CPU 100, a ROM 110, a RAM 120, an HDD 130, an input section 140, a display section 150, and a communication section 160. The information processing apparatus 10 is, for example, a general-purpose PC.

A CPU (Central Processing Unit) 100 is a central processing unit and performs calculations, logical determinations, and the like for various types of processes.

A read-only memory (ROM) 110 stores a control program executed by the CPU 100.

A random access memory (RAM) 120 is a main memory of the CPU 100, and provides a temporary storage area such as a work area.

A hard disk drive (HDD) 130 is a hard disk that stores data and programs according to the present embodiment. Note that an external storage device (not illustrated) may be used as a device that performs the same function as the HDD 130. Here, the external storage device includes, for example, a medium (recording medium) and an external storage drive for realizing access to the medium. Examples of the medium include a flexible disk (FD), a CD-ROM, a DVD, a USB memory, an MO, a flash memory, and the like. Furthermore, the external storage device may be a server device or the like connected via a network.

An input section 140 is a device that is configured by a keyboard, a touch panel, and the like and that accepts an input from a user.

A display section 150 is configured by a liquid crystal display or the like, and can display various types of data and processing results to the user. Furthermore, the display section 150 can communicate with another device (not illustrated) via a communication section 160. The other device may receive an instruction from the user via the communication section 160, or may output a processing result to the display section 150. The other device is, for example, a PC, a smartphone, and a tablet terminal.

FIG. 2 is a diagram illustrating a functional configuration of the information processing apparatus according to the first embodiment.

The information processing apparatus 10 includes a modeling section 201, a camera setting section 203, a distance information acquisition section 204, a depth map generation section 205, a defocus map generation section 206, and a rendering section 207. A 3D model DB 202 includes a three-dimensional model (also referred to as a 3D model) of a person and an object. Learning data 208 includes an output (defocus map) of the defocus map generation section 206 and an output (rendering image) of the rendering section 207.

The modeling section 201 can set a three dimensional model of the camera 301, the subject (e.g., the person 302a to the person 302c), and the background (the object 303 and the object 304) in a virtual three-dimensional space 300 of FIG. 3 described later. The modeling section 201 may select a three-dimensional model of the subject and the background from the 3D model DB 202. Furthermore, the modeling section 201 may determine an external photographing parameter which is a setting of a photographing direction of the camera 301.

FIG. 3 is a diagram illustrating an arrangement of 3D models in a three-dimensional space according to the first embodiment.

FIG. 3 illustrates an arrangement of the camera 301, the person 302a, the person 302b, the person 302c, the object 303, and the object 304 in the three-dimensional space 300. The camera 301 is a 3D model of the camera. The person 302a to the person 302c are 3D models of the persons. The person 302a to the person 302c can be arranged as different persons by changing the textures. An object 303 (illustrated as a cylinder) and an object 304 (illustrated as a cube) are 3D models of the objects. At least one of the object 303 and the object 304 can be arranged as an obstacle between the camera 301 and the person 302. Furthermore, the background of the person 302a can be presented by arranging the object 303 behind the person 302a (upward direction in FIG. 3).

The camera setting section 203 sets internal photographing parameters of the camera 301 arranged in the three-dimensional space 300. Here, the internal photographing parameters include, for example, settings such as a sensor size, a lens focal length, a focus position, a diaphragm value, a shutter speed, and an ISO sensitivity.

The distance information acquisition section 204 calculates the distance from the camera 301 to the subject (persons 302a to 302c) and the distance from the camera 301 to the background (object 303, object 304) over the entire photographing field of view area based on the photographing field of view (FOV) of the camera 301.

The depth map generation section 205 determines a depth value calculation region in the rendered image based on the photographing field of view of the camera 301. The depth value calculation region is, for example, a region including all of the 12×16 divided cells (partial regions). The depth map generation section 205 calculates a depth value for each cell (partial region) based on the distance information acquired by the distance information acquisition section 204. The depth value is obtained by aggregating depth information in a cell (partial region) into one value, and is an average value of distance information in a cell (partial region) in the present embodiment.

The defocus map generation section 206 calculates a defocus amount serving as an index of a focus shift amount for each cell from the depth value of each cell calculated by the depth map generation section 205, and generates a defocus map.

The rendering section 207 stores learning data 208 in which an image rendered based on internal and external photographing parameters of the camera 301 is associated with the defocus map generated by the defocus map generation section 206. Although it has been described that the rendering section 207 performs the storage process of the learning data 208, the defocus map generation section 206 may perform the storage process similar to the rendering section 207. Note that the rendering section 207 may appropriately add annotation information acquired based on computer graphics (CG) information for reproducing a 3D model to the learning data 208 according to the machine learning task. For example, in a case where the machine learning task is an object detection task, the rendering section 207 adds annotation information of the type (e.g., a person), coordinates, and size of the subject for each subject in the rendered image.

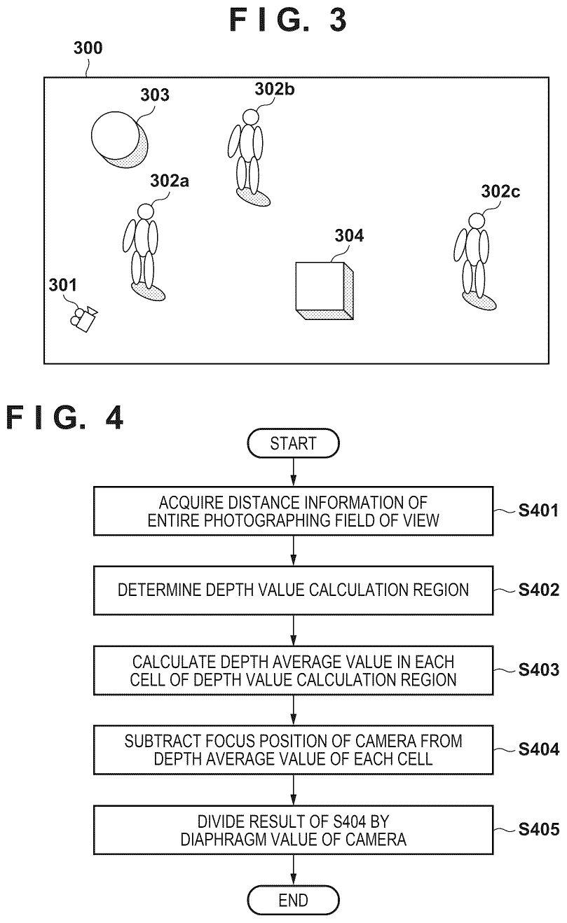

FIG. 4 is a flowchart illustrating a defocus map generation process according to the first embodiment. Note that the process of generating the defocus map is realized by the CPU 100 executing a program in the ROM 110.

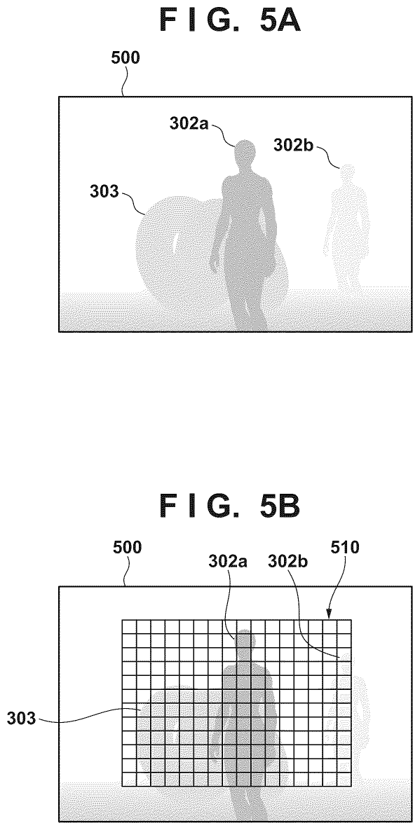

In S401, the distance information acquisition section 204 acquires the distance information from the camera 301 to the subject (the persons 302a to 302c) and the distance information from the camera 301 to the background (object 303, object 304) based on the photographing field of view (FOV) of the camera 301. For example, the distance information acquisition section 204 can acquire each of the above distance information based on computer graphics (CG) information for reproducing a 3D model. Here, as illustrated in FIG. 5A, the distance information is an image obtained by quantifying and visualizing the distance to the subject and the background in the entire photographing field of view of the camera 301.

FIGS. 5A and 5B are diagrams illustrating distance information and a depth value calculation region according to the first embodiment. FIG. 5A illustrates an example of distance information 500.

The distance information 500 indicates distances to the person 302a, the person 302b, and the object 303 with shades of color. In the distance information 500, the darker the color, the closer the subject is to the camera 301. On the other hand, in the distance information 500, the lighter the color, the farther the subject is from the camera 301. Here, the description returns to FIG. 4.

In step S402, the depth map generation section 205 determines the depth value calculation region 510 in the distance information 500 (e.g., an image).

Here, FIG. 5B is a diagram illustrating a depth value calculation region on the distance information. Note that the depth value calculation region 510 is used as a defocus amount calculation region to be described later.

The depth value calculation region 510 on the distance information 500 in FIG. 5B is a region divided into 12×16 cells. The depth value calculation region 510 also refers to the area around the main subject. The depth map generation section 205 sets the depth value calculation region 510 such that one cell (partial region) has a size (e.g., the size of one cell (partial region) is half of the face of the main subject) enough to sufficiently sample the depth value of the main subject. Here, the description returns to FIG. 4.

In S403, the defocus map generation section 206 calculates the depth average value of each cell in the depth value calculation region 510.

In S404, the defocus map generation section 206 calculates the defocus amount of each cell by subtracting the distance (i.e., the distance to the focal plane of the camera) to the focus position of the camera 301 from the depth average value of each cell.

In S405, the defocus map generation section 206 generates the defocus map by dividing the defocus amount of each cell acquired in S404 by the diaphragm value which is an internal photographing parameter of the camera 301. The phase difference AF method can directly calculate a shift amount of a focal plane from two images having parallax. However, in a case where the diaphragm value of the camera 301 is large, the baseline length becomes short, and thus sufficient parallax cannot be obtained and the defocus amount also becomes relatively small. As a result, the image rendered based on the photographing field of view of the camera 301 is an image in focus as a whole. Therefore, in a case where the diaphragm value of the internal photographing parameter of the camera 301 is set to be large, the defocus amount complying more with the actual photographing environment can be simulated by multiplying the defocus amount calculated in S405 by a gain so as to reduce the defocus amount. Then, the defocus map generation section 206 stores the learning data 208 in which the defocus map generated in S405 is associated with the image rendered by the rendering section 207, and ends the process.

In S405, the defocus map generation section 206 calculates the defocus amount by dividing the defocus amount acquired in S404 by the internal photographing parameter (specifically, the diaphragm value) of the camera 301, but the present invention is not limited thereto. For example, the defocus map generation section 206 may obtain in advance a table defining the relationship between the diaphragm value and the depth value for a specific lens, and determine the final defocus amount based on the table. As a result, it is possible to more faithfully reproduce the defocus amount of the lens of the actual camera.

Although it has been described that the average value is adopted as the representative value of the depth of each cell of the depth value calculation region 510 in S403, a most frequent value may be adopted. In a cell in which the distribution of the distance information has multimodality, there are a plurality of defocus amounts in which the correlation becomes large due to the characteristics of the correlation calculation of the phase difference AF method. However, the defocus amount obtained by averaging the defocus amounts becomes a defocus amount that does not in focus on any subject. The defocus map generation section 206 can determine one defocus amount from among defocus amounts having a high correlation by adopting the most frequent value.

As described above, according to the first embodiment, it is possible to obtain the defocus map in consideration of the actual photographing environment of the camera by using the three-dimensional model of the camera and the subject arranged in the virtual three-dimensional space. As a result, it is possible to efficiently acquire learning data in which an image showing an arbitrary subject and the defocus map are associated with each other.

### Image Capturing Apparatus for Inferring Distance

An image capturing apparatus in which a learned model learned based on learning data generated in the first embodiment is incorporated will be described.

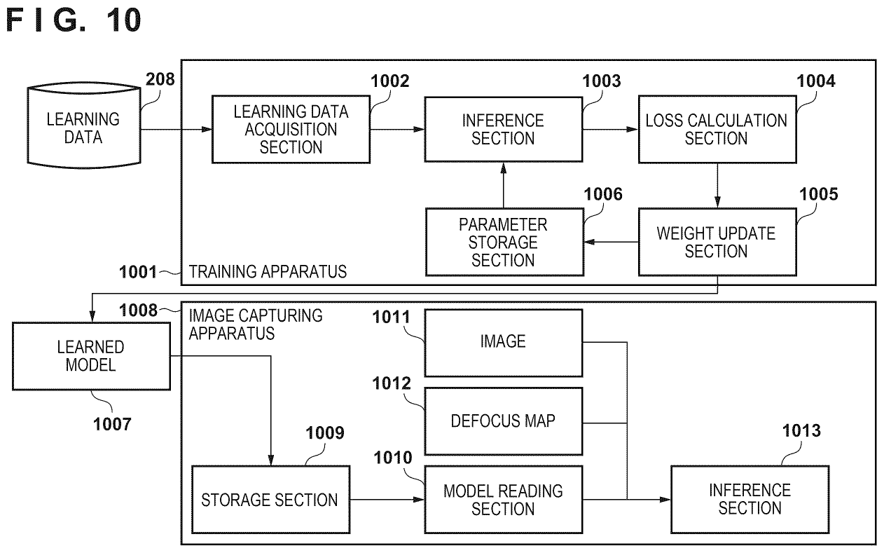

FIG. 10 illustrates a configuration example of a learning apparatus 1001 and an image capturing apparatus 1008 that perform learning using learning data 208.

In the learning apparatus 1001, the learning data acquisition section 1002 receives the learning data 208.

A distance to an object in an image is inferred by using an inference section 1003. The inference target is merely an example and may vary depending on the application.

A loss calculation section 1004 calculates a loss by comparing the inference result output from the inference section 1003 with the correct value acquired by the learning data acquisition section 1002. The loss function uses L1 loss, which is common in regression tasks.

A weight update section 1005 updates the weight of the network used in the machine learning from the loss calculated by the loss calculation section 1004. Thereafter, at the same time as outputting as the learned model 1007, the weight information is stored in a parameter storage section 1006, and the weight is used by the inference section 1003 at the time of next learning. At this time, the output destination is not limited to a specific format, and may be a memory of a general-purpose computer or a control circuit inside a camera. In the description of the present embodiment, description is made assuming that output is made to a storage section 1009 of the image capturing apparatus 1008 that can acquire the defocus map. The storage section 1009 is a recording medium such as a memory card.

The image capturing apparatus 1008 reads the learned model 1007 stored in the storage section 1009 by a model reading section 1010.

The inference section 1013 inputs an image 1011 and a defocus map 1012 to the learned model 1007 and obtains a distance inference result to the object in the image.

For example, various models such as a neural network such as a convolutional neural network (CNN), a vision transformer (ViT), and a support vector machine (SVM) combined with a feature extractor can be considered as the photographing parameter inference section 1003.

### Second Embodiment

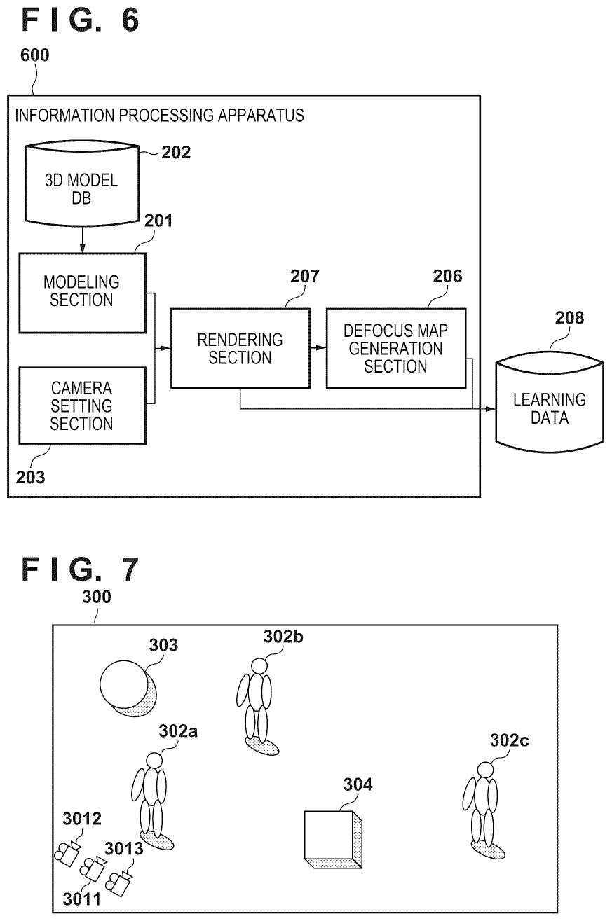

In a second embodiment, a defocus map is generated by arranging three-dimensional models of three cameras in a virtual three-dimensional space so as to obtain parallax information. Since the defocus map can be generated by a method close to the image capturing plane phase difference AF, learning data close to the defocus map acquired by the camera in the real space can be obtained. Hereinafter, a method of generating learning data (defocus map) will be described with reference to FIGS. 6 to 9. Note that in the second embodiment, a difference from the first embodiment will be described.

FIG. 6 is a diagram illustrating a functional configuration of an information processing apparatus according to a second embodiment. Note that in FIG. 6, the same functional blocks as those in FIG. 2 are denoted by the same reference numerals as those in FIG. 2.

The information processing apparatus 600 includes a modeling section 201, a camera setting section 203, a defocus map generation section 206, and a rendering section 207. Note that the information processing apparatus 600 does not include the distance information acquisition section 204 and the depth map generation section 205 as compared with the first embodiment, but is not limited thereto.

FIG. 7 is a diagram illustrating an arrangement of 3D models in a three-dimensional space according to the second embodiment.

As illustrated in FIG. 7, the rendering section 207 renders three images based on three kinds of photographing field of views arranged at equal intervals in the baseline length direction between the camera 3012 and the camera 3013. The first photographing field of view is a photographing field of view based on an arbitrary photographing direction of the camera 3011. The camera 3011 is disposed, for example, at the same position as the camera 301 of FIG. 3. The second photographing field of view is a photographing field of view of the camera 3012 disposed away from the first photographing field of view by −b/2 in the longitudinal direction (baseline length direction). The third photographing field of view is a photographing field of view of the camera 3013 disposed away from the first photographing field of view by +b/2 in the longitudinal direction (baseline length direction). Note that the internal photographing parameters of the camera 3011 to the camera 3013 are set to be the same. Furthermore, the external photographing parameters of the camera 3011 to the camera 3013 are set to be the same except for the camera coordinates for creating parallax. As a result, parallax information based on the condition of the baseline length b (not illustrated) between the camera 3012 and the camera 3013 can be obtained.

FIG. 9 is a flowchart illustrating a defocus map generation process according to the second embodiment. Note that the process of generating the defocus map is realized by the CPU 100 executing a program in the ROM 110.

In S901, the rendering section 207 renders the “left-eye image” based on the photographing parameters of the camera 3012. The rendering section 207 renders the “right-eye image” based on the photographing parameters of the camera 3013. The rendering section 207 renders a “double-eye image” which is an image of an intermediate photographing field of view of the left-eye image and the right-eye image based on the photographing parameters of the camera 3011.

In S902, the defocus map generation section 206 determines a defocus amount calculation region (not illustrated) in the double-eye image, and divides the defocus amount calculation region into, for example, 12×16 cells. Note that this defocus amount calculation region (first region) is similar to the depth value calculation region in FIG. 5B.

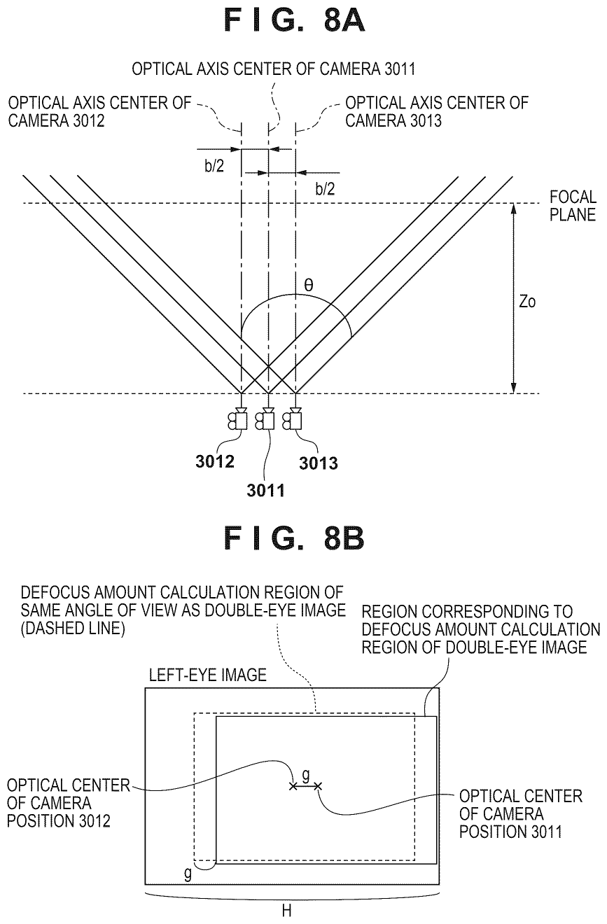

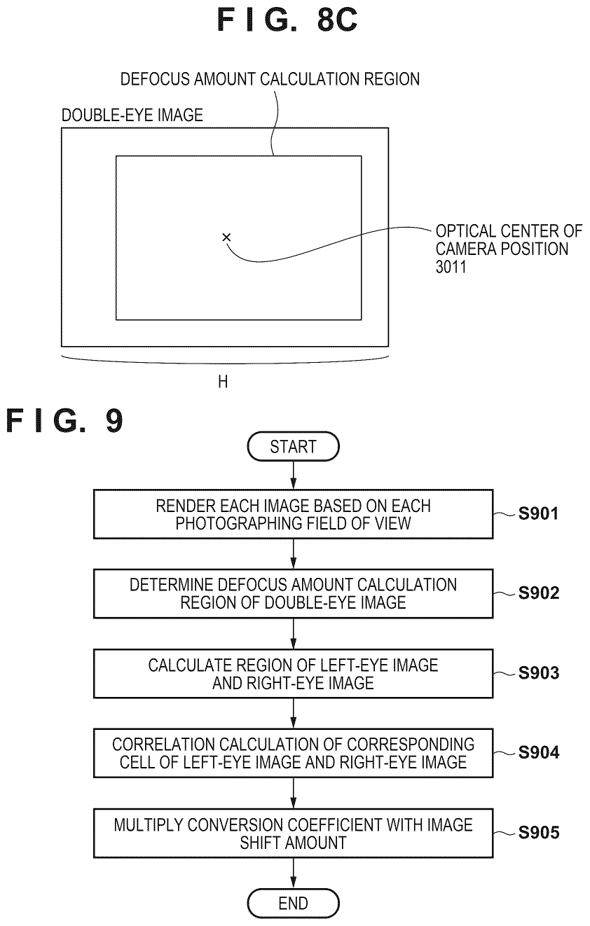

In S903, the defocus map generation section 206 calculates a region (the second region of the left-eye image and the third region of the right-eye image) corresponding to the defocus amount calculation region calculated in S902 in each of the left-eye image and the right-eye image, and calculates a defocus amount for each corresponding cell. Hereinafter, a method of aligning the defocus amount calculation region calculated in S902 with respect to the left-eye image and the right-eye image will be described with reference to FIGS. 8A to 8C.

The alignment of the defocus amount calculation region according to the second embodiment will be described with reference to FIGS. 8A to 8C. FIG. 8A is a view of the cameras 3011 to 3013 as viewed from the short side direction of the sensor. Where θ represents the horizontal angle of view of the sensor.

A distance from the sensor center of the camera 3011 to the camera 3013 to the focal plane is assumed to be Zo. At this time, the photographing field of view in the horizontal (long axis) direction of the sensor in the focal plane is represented by 2Zotan (θ/2). This photographing field of view is a range recorded in the horizontal pixel of the image. Therefore, the shift amount g between the optical center of the camera 3011 and the optical center of the camera 3012 in the left-eye image is calculated by Formula (1) with the horizontal resolution of the camera as H.

$$b / 2 : 2 Zo tan ( θ / 2 ) = g : H \qquad ( 1 )$$

That is, in the left-eye image of FIG. 8B, by shifting the defocus amount calculation region having the same angle of view as that of the double-eye image of FIG. 8C to the right by g, a region of the left-eye image corresponding to the defocus amount calculation region of the double-eye image can be obtained. Similarly, in the right-eye image (not shown), by shifting the defocus amount calculation region having the same angle of view as that of the double-eye images to the left by g, a region of the right-eye image corresponding to the defocus amount calculation region of the double-eye images can be obtained. A method for calculating the defocus amount will be described below. The description returns to FIG. 9.

In S904, the defocus map generation section 206 performs correlation calculation process between corresponding cells of the left-eye image and the right-eye image to calculate a shift amount of an image (image shift amount) in the corresponding cell of the double-eye image.

Specifically, the averaging process is performed in the column direction in the corresponding cells of the left-eye image and the right-eye image to acquire the left-eye signal and the right-eye signal. Shift process for relatively shifting the corresponding cells in the row direction is performed to calculate a correlation amount COR(s) representing the degree of coincidence of signals.

Assume that a left-eye signal in a kth column in a certain cell is A (k), a right-eye signal is B (k), and a range of k corresponding to the cell is W. A shift amount by the shift process is represented by s, and a shift range of the shift amount s is represented by Γ. At this time, the correlation amount COR(s) is calculated by Formula (2).

$$C O R ( s ) = {\sum }_{k ∈ W} \vert A ( k ) - B ( k - s ) \vert , s ∈ Γ \qquad ( 2 )$$

The left-eye signal A (k) of the kth column and the right-eye signal B (k-s) of the k-sth column are made to correspond to each other and subtracted by the shift process of the shift amount s to generate a shift subtraction signal. An absolute value of the generated shift subtraction signal is calculated, a sum is obtained within a range W corresponding to the cell region, and a correlation amount COR (s) is calculated. Since the correlation amount COR(s) is obtained for each column, the shift amount s of the actual value at which the correlation amount COR(s) becomes the minimum value is calculated using three-point interpolation or the like and set as the image shift amount.

In S905, the defocus map generation section 206 calculates the defocus amount d by multiplying the image shift amount by the conversion coefficient K. Here, the conversion coefficient K is a parameter that changes according to the baseline length b between the position of the camera 3012 and the position of the camera 3013. The conversion coefficient K corresponds to a conversion coefficient for converting an image shift amount in pixel units into a defocus amount in the image capturing plane phase difference AF.

The defocus map generation section 206 performs the same calculation as described above for all of the 12×16 cells, and eventually obtains a defocus map of the double-eye image.

The defocus map generation section 206 stores the learning data 208 in which the defocus map of the double-eye image generated in S905 is associated with the double-eye image rendered by the rendering section 207, and ends the process.

As described above, according to the second embodiment, the defocus map can be calculated based on the parallax information between the left-eye image and the right-eye image. In addition, learning data in which an image in which an arbitrary subject appears is associated with a defocus map simulating sensor characteristics and optical characteristics of the image capturing plane phase difference AF can be efficiently acquired.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-183528, filed Oct. 25, 2023, and Japanese Patent Application No. 2024-175265, filed Oct. 4, 2024 which are hereby incorporated by reference herein in their entirety.

What is claimed is:

1. An information processing apparatus comprising:
at least one processor; and
at least one memory coupled to the at least one processor, the at least one memory storing instructions that, when executed by the at least one processor, cause the at least one processor to:
arrange a three-dimensional model of a subject and a camera in a virtual three-dimensional space;
generate a depth map including at least a depth value of a partial region of a region around the subject, based on an image in which the subject appears, the image being rendered based on a photographing field of view of the camera, and distance information corresponding to the photographing field of view; and
generate a defocus map including a defocus amount of the partial region based on a depth value of the partial region and a photographing parameter of the camera.

2. The information processing apparatus according to claim 1, wherein the defocus amount of the partial region is a value obtained by subtracting a distance to a focal plane of the camera from the depth value of the partial region.

3. The information processing apparatus according to claim 2, wherein the at least one processor adjusts the subtracted value according to a magnitude of a photographing parameter of the camera.

4. The information processing apparatus according to claim 1, wherein the at least one processor determines the defocus amount of the partial region based on information in which a diaphragm value corresponding to a predetermined lens of the camera and a depth value of the partial region are associated with each other.

5. The information processing apparatus according to claim 1, wherein the depth value of the partial region is an average value.

6. The information processing apparatus according to claim 1, wherein the depth value of the partial region is a most frequent value.

7. The information processing apparatus according to claim 1, wherein the partial region has a size covering at least a part of a face of the subject.

8. The information processing apparatus according to claim 1, wherein the photographing parameter of the camera is a diaphragm value.

9. The information processing apparatus according to claim 1, wherein the instructions, when executed by the at least one processor, further cause the at least one processor to store the image and the defocus map in association with each other.

10. An image capturing apparatus that obtains an inference result for a subject in a photographed image based on a learned model learned using the defocus map generated by the information processing apparatus according to claim 1.

11. A method comprising:
arranging a three-dimensional model of a subject and a camera in a virtual three-dimensional space;
generating a depth map including at least a depth value of a partial region of a region around the subject, based on an image in which the subject appears, the image being rendered based on a photographing field of view of the camera, and distance information corresponding to the photographing field of view; and
generating a defocus map including a defocus amount of the partial region based on a depth value of the partial region and a photographing parameter of the camera.

12. A non-transitory computer readable storage medium storing instructions that, when executed by a computer, cause the computer to perform a method comprising:
arranging a three-dimensional model of a subject and a camera in a virtual three-dimensional space;
generating a depth map including at least a depth value of a partial region of a region around the subject, based on an image in which the subject appears, the image being rendered based on a photographing field of view of the camera, and distance information corresponding to the photographing field of view; and
generating a defocus map including a defocus amount of the partial region based on a depth value of the partial region and a photographing parameter of the camera.

13. An information processing apparatus comprising:
at least one processor; and
at least one memory coupled to the at least one processor, the at least one memory storing instructions that, when executed by the at least one processor, cause the at least processor to:
arrange a three dimensional model of a subject in a virtual three dimensional space, and arrange three dimensional models of a first camera, a second camera, and a third camera at intervals so that optical axes of the first camera, the second camera, and the third camera are parallel to each other;
determine at least a first region around the subject in a double-eye image in which the subject is captured, the double-eye image being rendered based on a first photographing field of view of the first camera; and
generate a defocus map including a defocus amount of a partial region of the first region based on parallax information of a partial region of a second region corresponding to the first region in a left-eye image in which the subject is captured, the left-eye image being rendered based on a second photographing field of view of the second camera and a partial region of a third region corresponding to the first region in a right-eye image in which the subject is captured, the right-eye image being rendered based on a third photographing field of view of the third camera.

14. The information processing apparatus according to claim 13, wherein the at least one processor disposes the first camera at a midpoint of a baseline length between a position of the second camera and a position of the third camera.

15. The information processing apparatus according to claim 14, wherein the at least one processor determines the defocus amount of the partial region of the first region based on a magnitude of the baseline length.

16. A method comprising:
arranging a three dimensional model of a subject in a virtual three dimensional space, and arrange three dimensional models of a first camera, a second camera, and a third camera at intervals so that optical axes of the first camera, the second camera, and the third camera are parallel to each other;
determining at least a first region around the subject in a double-eye image in which the subject is captured, the double-eye image being rendered based on a first photographing field of view of the first camera; and
generating a defocus map including a defocus amount of a partial region of the first region based on parallax information of a partial region of a second region corresponding to the first region in a left-eye image in which the subject is captured, the left-eye image being rendered based on a second photographing field of view of the second camera and a partial region of a third region corresponding to the first region in a right-eye image in which the subject is captured, the right-eye image being rendered based on a third photographing field of view of the third camera.

17. A non-transitory computer readable storage medium storing instructions that, when executed by a computer, cause the computer to perform a method comprising:
arranging a three dimensional model of a subject in a virtual three dimensional space, and arrange three dimensional models of a first camera, a second camera, and a third camera at intervals so that optical axes of the first camera, the second camera, and the third camera are parallel to each other;
determining at least a first region around the subject in a double-eye image in which the subject is captured, the double-eye image being rendered based on a first photographing field of view of the first camera; and
generating a defocus map including a defocus amount of a partial region of the first region based on parallax information of a partial region of a second region corresponding to the first region in a left-eye image in which the subject is captured, the left-eye image being rendered based on a second photographing field of view of the second camera and a partial region of a third region corresponding to the first region in a right-eye image in which the subject is captured, the right-eye image being rendered based on a third photographing field of view of the third camera.
